(19) United States
(12) Patent Application Publication
(10) Pub. No.: US 2023/0300230 A1
(43) Pub. Date: Sep. 21, 2023

(54) Mobile airbag bracket structure

(71) Applicant: Guoling Zhao, Xinning County (CN)

(72) Inventor: Guoling Zhao, Xinning County (CN)

(21) Appl. No.: 18/202,326

(22) Filed: May 26, 2023

(51) Int. Cl. H04M 1/02

(52) U.S. Cl. CPC H04M 1/0281

(57) ABSTRACT

A mobile airbag bracket structure includes a main part including an airbag and a decorative cover. One end of the airbag is provided with a circular base protruding from the bottom of the airbag. The surface of the decorative cover is equipped with a groove having a sidewall of the groove provided with a card slot. The diameter of the base is greater than the opening diameter of the groove. The thickness of the base is smaller than or equal to the depth of the card slot. The airbag is installed in the groove of the decorative cover through the base. The base is inserted into the card slot on the sidewall of the groove to fasten the airbag.

### BACKGROUND OF THE INVENTION

### 1. Field of the Invention

The invention relates to mobile airbag brackets and more particularly to a convenient-to-assemble and easy-to-use mobile airbag bracket structure.

### 2. Description of Related Art

A mobile airbag bracket is a device fixed on the back of a mobile phone, which allows for easy grip by the user. However, the conventional airbag brackets have a rigid plastic construction at the end in contact with the user's fingers, making the users feel uncomfortable when holding it for a long time. To address this issue, many manufacturers or users would add a decorative cover to the end of the airbag bracket in contact with the fingers, increasing the contact area with the fingers to reduce the discomfort and provide a more secure grip. However, the decorative cover is typically fixed to the airbag bracket with adhesive, making it unable and inconvenient to remove during use. If the decorative cover is damaged, the entire bracket becomes unusable. Additionally, the fixed design of the decorative cover increases the overall size of the product, making it less portable.

Thus, the need for improvement still exists.

### SUMMARY OF THE INVENTION

To overcome the above drawbacks of the prior art, embodiments of the invention provide a convenient-to-assemble and easy-to-use mobile airbag bracket structure to address the problems identified in the background art.

To achieve the above objectives, the invention provides the following technical solution: A convenient-to-assemble and easy-to-use mobile airbag bracket structure comprises a main part, which includes an airbag and a decorative cover.

One end of the airbag is equipped with a circular base protruding from the bottom of the airbag.

The surface of the decorative cover is provided with a groove and the cavity sidewall of the groove is equipped with a card slot.

The diameter of the base is greater than the opening diameter of the groove.

The thickness of the base is smaller than or equal to the depth of the card slot.

The decorative cover is made of an elastic material.

The airbag is installed in the groove of the decorative cover through the base, with the base inserted into the card slot on the sidewall of the groove, realizing its fixation and enabling a convenient and secure installation.

As an optimization, the base can also be designed as a rectangular or polygonal structure.

As an optimization, the base on the airbag is compatible with the groove on the decorative cover.

As an optimization, the decorative cover can be designed as a structure of any shape and is compatible with the airbag.

As an optimization, the other end of the airbag is fixedly connected to the mobile phone using magnetic attachment or adhesive tape.

The invention has the following advantages and benefits in comparison with the conventional art:

The invention provides a solution by incorporating a protruding base at one end of the airbag and creating a groove in match with the base on the elastic surface of the decorative cover. The cavity sidewalls of the groove are equipped with a card slot. As for the installation, the base of the airbag needs to be inserted into the card slot in the groove, allowing for quick and easy assembly. When the decorative cover is not needed or becomes damaged, it can be quickly removed for storage, replacement or use with other compatible decorative covers. This provides great convenience while maintaining a simple and reasonable structure.

The above and other objects, features and advantages of the invention will become apparent from the following detailed description taken with the accompanying drawings.

### BRIEF DESCRIPTION OF THE DRAWINGS

FIG. 1 is a perspective view of a convenient-to-assemble and easy-to-use mobile airbag bracket structure of the invention;

FIG. 2 is an exploded view of the convenient-to-assemble and easy-to-use mobile airbag bracket structure in FIG. 1;

FIG. 3 is a perspective view of the airbag;

FIG. 4 is a perspective view of the decorative cover structure; and

FIG. 5 is an environmental view showing the convenient-to-assemble and easy-to-use mobile airbag bracket structure held by the hand in use with a mobile phone.

### DETAILED DESCRIPTION OF THE INVENTION

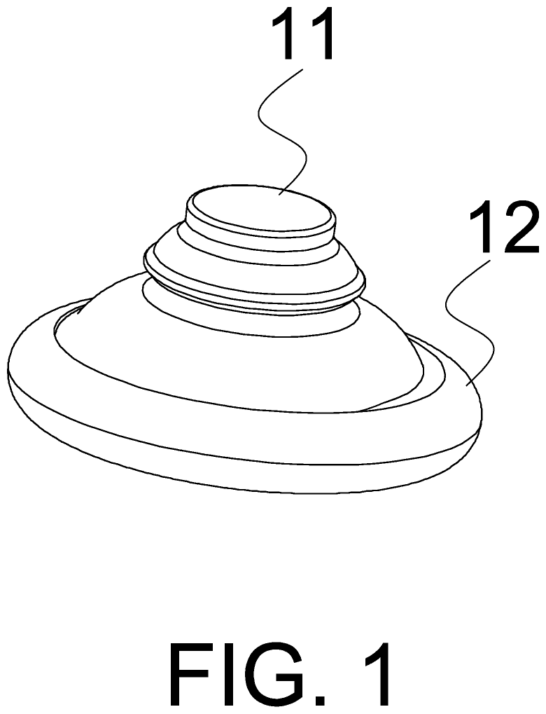

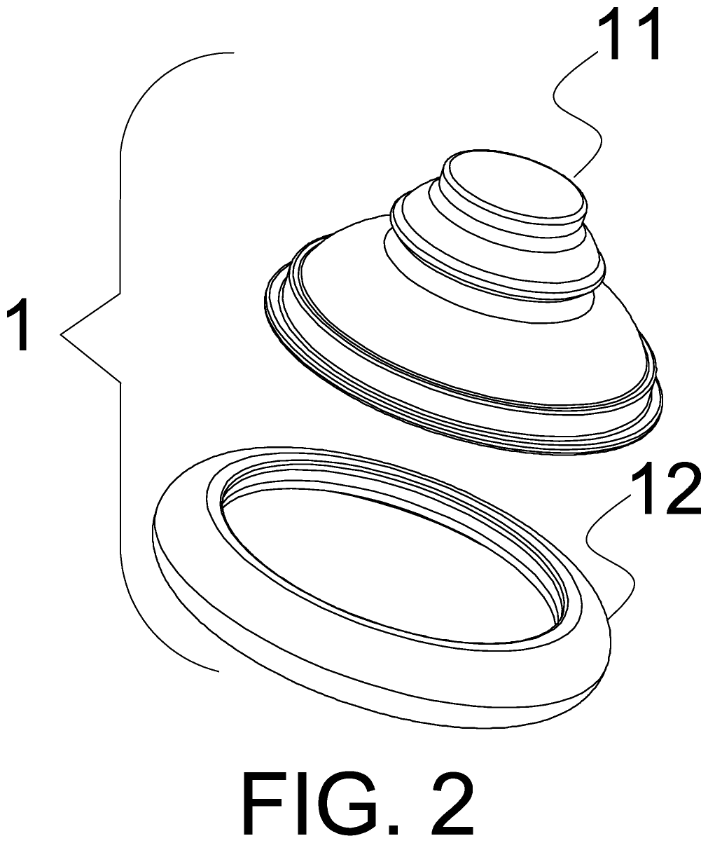

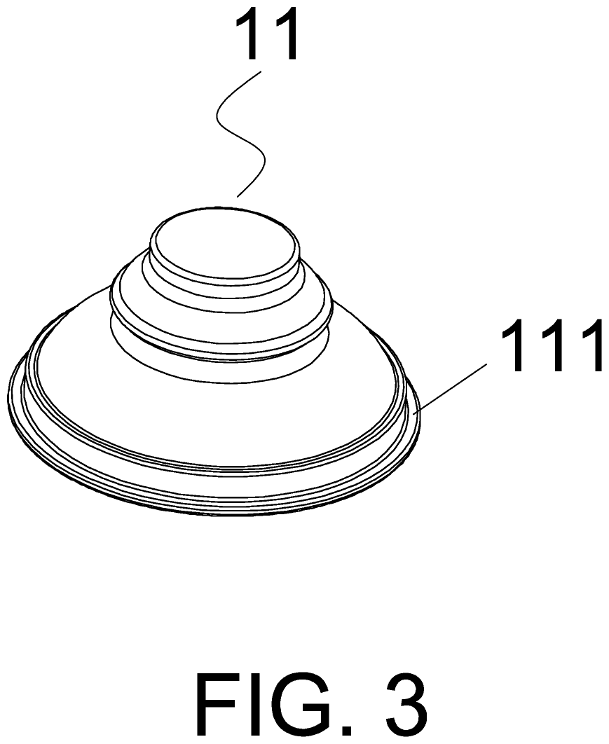

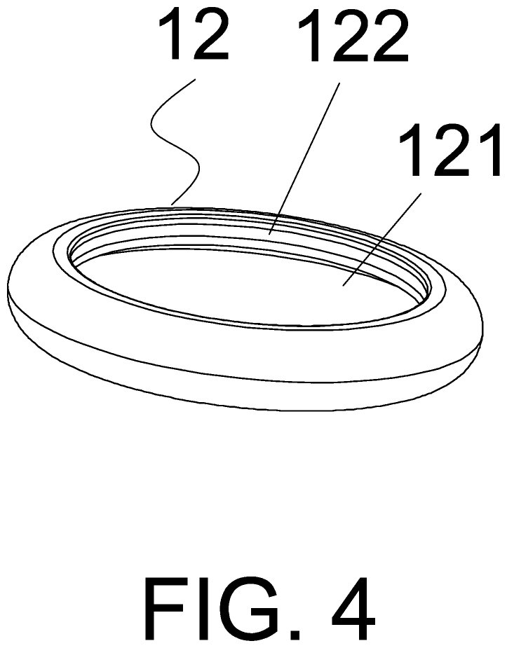

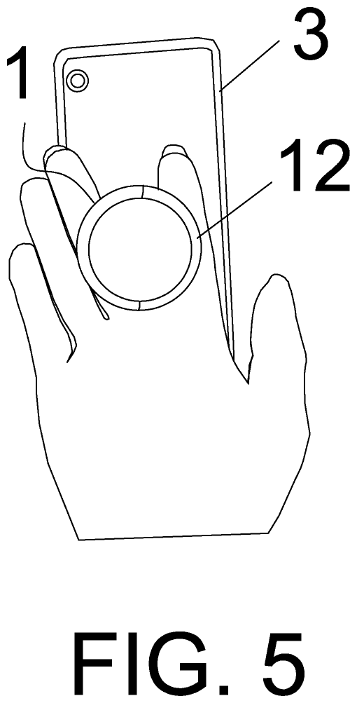

Referring to FIGS. 1 to 5, a convenient-to-assemble and easy-to-use mobile airbag bracket structure of the invention comprises a main part 1. The main part 1 includes an airbag 11 and a decorative cover 12. The airbag 11 is flexible and can be folded and stored in multiple layers. The bottom of the airbag 11 is equipped with a circular base 111 that protrudes from the bottom of the airbag 11. The surface of the decorative cover 12 features a groove 121, and the cavity sidewall of the groove 121 is provided with a slot 122. The diameter of the base 111 is larger than the opening diameter of the groove 121, effectively preventing the base 111 from detaching from the groove 121. The thickness of the base 111 is smaller than or equal to the depth of the slot 122. The decorative cover 12 is made of elastic material, which ensures that users can hold a mobile phone 3 for a long time without discomfort. The airbag 11 is installed in the groove 121 of the decorative cover 12 through the base 111, with the base 111 inserted into the slot 122 on the sidewall of the groove 121, thereby achieving the fixation of the airbag and its convenient installation.

The base 111 can be optionally designed as a rectangular or polygonal structure. The base 111 on the airbag 11 is compatible with the groove 121 on the decorative cover 12. The decorative cover 12 can be designed as structure of any shapes and is compatible with the airbag 11. By providing different shapes of the decorative cover 12, customers have more choices. For example, female users may prefer cute and adorable designs, while male users may prefer simple and minimalist designs. The other end of the airbag 11 is fixedly connected to the mobile phone 3 using magnetic attachment or adhesive.

Working Principle of the Invention

The main part 1 of the invention mainly consists of an airbag 11 and a decorative cover 12. One end of the airbag 11 is equipped with a protruding base 111, while the surface of the decorative cover 12 is designed with a compatible groove 121. The inner cavity sidewall of the groove 121 is equipped with the slot 122. As for installation, the base 111 of the airbag 11 needs to be fitted into the groove 121 and the base 111 needs to be inserted into the slot 122. This process is quick and easy. When the decorative cover 12 is not needed or becomes damaged, it can be quickly removed for storage, replacement or use with other compatible decorative covers 12. This provides great convenience in use while maintaining a simple and reasonable structure. The decorative cover 12 is made of elastic material, allowing users to hold the mobile phone 3 for a long time without discomfort. It is highly practical. By providing different shapes of the decorative cover 12, users have more choices, which is advantageous for market sales. If the decorative cover 12 is damaged, users can purchase a compatible replacement cover 12 separately. The airbag 11 is a collapsible and expandable structure (a technology known in the field, not described in detail here). When using the main part 1, the airbag 11 is stretched and gripped in any finger gap, supported and limited by the decorative cover 12. This provides a firmer grip on the mobile phone 3, making it more convenient and comfortable to hold the mobile phone 3 for extended periods.

While the invention has been described in terms of preferred embodiments, those skilled in the art will recognize that the invention can be practiced with modifications within the spirit and scope of the appended claims.

What is claimed is:

1. A convenient-to-assemble and easy-to-use mobile airbag bracket structure, comprising a main part wherein:
the main part comprises an airbag and a decorative cover;
one end of the airbag is provided with a base, which has a circular structure and protrudes from the bottom of the airbag;
the surface of the decorative cover is equipped with a groove, and the cavity sidewall of the groove is provided with a card slot;
the diameter of the base is greater than the opening diameter of the groove;
the thickness of the base is smaller than or equal to the depth of the card slot;
the decorative cover is made of an elastic material;
the airbag is installed in the groove of the decorative cover through the base; and
the base is inserted into the card slot on the sidewalls of the groove, achieving the fixation of the airbag and enabling a convenient installation.

2. The convenient-to-assemble and easy-to-use mobile airbag bracket structure of claim 1, wherein the base can also be designed as a rectangular or polygonal structure.

3. The convenient-to-assemble and easy-to-use mobile airbag bracket structure of claim 1, wherein the base of the airbag is compatible with the groove on the decorative cover.

4. The convenient-to-assemble and easy-to-use mobile airbag bracket structure of claim 1, wherein the decorative cover can be designed as a structure of any shape and is compatible with the airbag.

5. The convenient-to-assemble and easy-to-use mobile airbag bracket structure of claim 1, wherein the other end of the airbag is fixedly connected to the mobile phone using magnetic attachment or adhesive tape.
